(19) United States
(12) Patent Application Publication
(10) Pub. No.: US 2014/0271202 A1
(43) Pub. Date: Sep. 18, 2014

(54) Assembly for Pitch Control System

(71) Applicant: Heartland Energy Solutions, LLC., Mt. Ayr, IA (US)

(72) Inventor: Jeffrey Todd Blanton, Mt. Ayr, IA (US)

(21) Appl. No.: 13/838,558

(22) Filed: Mar. 15, 2013

(51) Int. Cl. F03D 7/02; F03D 11/00

(52) U.S. Cl. CPC F03D 7/0224; F03D 11/0008
USPC 416/147; 384/548; 384/584

(57) ABSTRACT

In accordance with example embodiments, an assembly may include a first interfacing member, a second interfacing member, a first bearing between the first interfacing member and the second interfacing member, and a set of rollers between the second interfacing member and a shaft of the first interfacing member. In example embodiments the first interfacing member may include a first mounting portion and the second interfacing member may include a second mounting portion. In example embodiments, the first mounting portion may be configured to attach to a first structure, for example a wind turbine blade, and the second mounting portion may be configured to attach to a second structure, for example, a hub of a wind turbine.

### BACKGROUND

1. Field

Example embodiments disclose an assembly. In example embodiments, the assembly may be used to control a pitch of a structure, for example, a wind turbine blade.

2. Description of the Related Art

Wind turbines are mechanical devices that convert wind energy to electrical power. FIG. 22 is a view of a conventional wind turbine 10. As shown in FIG. 22, a conventional wind turbine 10 includes a tower 20 that supports a generator 30 and a plurality of blades 40, also referred to as air foils. Wind exerts a force on the blades 40 causing them to spin about an axis of rotation Z. The generator 30 converts the blade's motion to electrical power. Thus, the wind turbine 10 is capable of converting wind energy into electricity.

In the conventional art, excessive winds, for example, wind gusts, may cause excessive stresses in the blades 40, the generator 30, and the tower 20. To relieve these stresses, some conventional wind turbines include actuators that change an orientation of the blades. Generally, these actuators are attached to a slewing bearing which is housed in a hub 50 of the wind turbine. Together, the actuators and the slewing bearing control a pitch of a wind turbine blade 40.

### SUMMARY

As explained above, slewing bearings are commonly used in the wind industry to control a pitch of a wind turbine blade. Though their performance is generally satisfactory, they are expensive to produce and require long lead times for manufacturing. Currently there are few alternatives to stewing bearings on the market. Thus applicants have set out to design an assembly with multiple purposes, one of which may replace the conventional slewing bearings used for controlling the pitch of a wind turbine blade.

In accordance with example embodiments, an assembly may include a first interfacing member, a second interfacing member, a first bearing between the first interfacing member and the second interfacing member, and a set of rollers between the second interfacing member and a shaft of the first interfacing member. In example embodiments the first interfacing member may include a first mounting portion and the second interfacing member may include a second mounting portion. In example embodiments, the first mounting portion may be configured to attach to a first structure, for example a wind turbine blade, and the second mounting portion may be configured to attach to a second structure, for example, a hub of a wind turbine.

In accordance with example embodiments, a wind turbine may include a turbine blade, a hub, and an assembly configured to rotate the turbine blade with respect to the hub. In example embodiments, the assembly may include a first interfacing member, a second interfacing member, a first bearing between the first interfacing member and the second interfacing member, and a set of rollers between the second interfacing member and a shaft of the first interfacing member. In example embodiments the first interfacing member may include a first mounting portion and the second interfacing member may include a second mounting portion. In example embodiments the first turbine blade may be attached to the first mounting portion and the hub may be attached to the second mounting portion.

### BRIEF DESCRIPTION OF THE DRAWINGS

FIG. 1 is a perspective view of an assembly in accordance with example embodiments;

FIG. 2 is a front view of the assembly in accordance with example embodiments;

FIG. 3 is a cross section view of the assembly in accordance with example embodiments;

FIG. 4 is a cross-section/perspective view of a first interfacing member of the assembly in accordance with example embodiments;

FIG. 5A is a cross-section/perspective view of a first bearing in accordance example embodiments;

FIG. 5B is a cross-section/perspective/exploded view of the first bearing in accordance with example embodiments;

FIG. 5C illustrates a various parts of the first bearing in accordance with example embodiments;

FIG. 5D illustrates various parts of the first bearing in accordance with example embodiments;

FIG. 5E illustrates various parts of the first bearing in accordance with example embodiments;

FIGS. 6A and 6B are cross-section/perspective views of the first bearing combined with the first interfacing member in accordance with example embodiments; and

FIGS. 7A and 7B are cross-section/perspective views of a second interfacing member in accordance with example embodiments;

FIG. 8 is a cross-section/perspective view of a roller in accordance with example embodiments;

FIG. 9 illustrates an example of the roller combined with the second interfacing member in accordance with example embodiments;

FIG. 10 illustrates a cross-section/perspective view of the first interfacing member, the first bearing, and the second interfacing member combined together in accordance with example embodiments;

FIG. 11 is a cross-section/perspective view of a second bearing in accordance with example embodiments;

FIG. 12 illustrates a cross-section/perspective view of the first interfacing member, the first bearing, the second interfacing member, and the second bearing combined together in accordance with example embodiments;

FIG. 13 is a cross-section/perspective view of a cover in accordance with example embodiments;

FIG. 14 illustrates a cross-section/perspective view of the first interfacing member, the first bearing, the second interfacing member, the second bearing, and the cover combined together in accordance with example embodiments;

FIG. 15 is a cross-section/perspective view of a first clamp in accordance with example embodiments;

FIG. 16 is a cross-section/perspective view of a lock washer in accordance with example embodiments;

FIG. 17 illustrates a cross-section/perspective view of the first interfacing member, the first bearing, the second interfacing member, the second bearing, the cover, the first clamp, and the lock washer combined together in accordance with example embodiments;

FIG. 18 is a cross-section/perspective view of a nut in accordance with example embodiments;

FIG. 19 illustrates a cross-section/perspective view of the first interfacing member, the first bearing, the second interfacing member, the second bearing, the cover, the first clamp, the lock washer, and the nut combined together in accordance with example embodiments;

FIG. 20 is a cross-section/perspective view of a second clamp in accordance with example embodiments; and

FIG. 21 illustrates a cross-section/perspective view of the first interfacing member, the first bearing, the second interfacing member, the second bearing, the cover, the first clamp, the lock washer, the nut, and the second clamp combined together in accordance with example embodiments;

FIG. 22 is a view of a conventional wind turbine.

### DETAILED DESCRIPTION

Example embodiments of the invention will now be described with reference to the accompanying drawings. Example embodiments, however, should not be construed as limiting the invention since the invention may be embodied in different forms. Example embodiments illustrated in the figures are provided so that this disclosure will be thorough and complete. In the drawings, the sizes of components may be exaggerated for clarity.

In this application, when an element is referred to as being “on,” “attached to,” “connected to,” or “coupled to” another element, it can be directly on, attached to, connected to, or coupled to the other element or intervening elements that may be present. On the other hand, when an element is referred to as being “directly on,” “directly attached to,” “directly connected to,” or “directly coupled to” another element, there are no intervening elements present. In example embodiments, when an element is referred to as “contacting” another element, it may directly contact the other element or contact an intervening element that may be present. In this application, when an element is referred to as “directly contacting” another element, there is no intervening element. As used herein, the term “and/or” includes any and all combinations of one or more of the associated listed items.

In this application, the terms first, second, etc. are used to describe various elements, components, regions, layers, and/or sections. However, these elements, components, regions, layers, and/or sections should not be limited by these terms since these terms are only used to distinguish one element, component, region, layer, and/or section from other elements, components, regions, layers, and/or sections that may be present. For example, a first element, component region, layer or section discussed below could be termed a second element, component, region, layer, or section.

In this application, spatial terms, such as “beneath,” “below,” “lower,” “over,” “above,” and “upper” (and the like) are used for ease of description to describe one element or feature's relationship to another element(s) or feature(s). The invention, however, is not intended to be limited by these spatial terms. For example, if an example of the invention illustrated in the figures is turned over, elements described as “over” or “above” other elements or features would then be oriented “under” or “below” the other elements or features. Thus, the spatial term “over” may encompass both an orientation of above and below. The device may be otherwise oriented (for example, rotated 45 degrees, 90 degrees, 180 degrees, or at other orientations) and the spatially relative descriptors used herein interpreted accordingly.

In this application, example embodiments may be described by referring to plan views and/or cross-sectional views which may be ideal schematic views. However, it is understood the views may be modified depending on manufacturing technologies and/or tolerances. Accordingly, the invention is not limited by the examples illustrated in the views, but may include modifications in configurations formed on the basis of manufacturing process. Therefore, regions illustrated in the figures are schematic and exemplary and do not limit the invention.

The subject matter of example embodiments, as disclosed herein, is described with specificity to meet statutory requirements. However, the description itself is not intended to limit the scope of this patent. Rather, the inventors have contemplated that the claimed subject matter might also be embodied in other ways, to include different features or combinations of features similar to the ones described in this document, in conjunction with other technologies. Generally, example embodiments disclose an assembly. In example embodiments, the assembly may be used to control a pitch of a structure, for example, a wind turbine blade.

FIG. 1 is a perspective view of an assembly 1000 in accordance with example embodiments. In example embodiments, the assembly 1000 may be usable for controlling a rotation of a structure, for example, a wind turbine blade. FIG. 2 is a front view of the assembly 1000 in accordance with example embodiments and FIG. 3 is a section view of the assembly 1000 taken through line III-III of FIG. 2. FIGS. 3-21 illustrate section/perspective views of various components of the assembly 1000. It is understood that each of the elements maybe substantially symmetrical. Thus, in example embodiments, only half of the internal structures are shown to better describe the elements of example assembly 1000.

Referring to FIG. 3, the assembly 1000 of example embodiments may be comprised of a first interfacing member 100, a first bearing 200, a second interfacing member 300, a second bearing 400, a cover 500, a first clamp 600, a nut 700, a second clamp 800, and an arm 900. As shown in at least FIG. 3, the first bearing 200 may be between the first interfacing member 100 and the second interfacing member 300, the second bearing 400 may be between the second interfacing member 300 and the cover 500, and the cover may be between the nut 700 and the second bearing 400. In example embodiments, a set of rollers 350 (see at least FIG. 8 for labeling) may be partially enclosed by the second interfacing member 300. The set of rollers 350 may, in turn, enclose a portion of a shaft 150 of the first interfacing member 100.

As will be explained, various elements of the assembly 1000 are rotatable about an axis line A-A that runs through the first interfacing member 100, even when one or more members, for example, the second interfacing member 300, is fixed to an external structure. For example, in the event the second interfacing member 300 is fixed to an external structure, for example, a hub of a wind turbine, each of the first interfacing member 100, the cover 500, the first clamp 600, the nut 700, the second clamp 800, and the arm 900 may rotate or revolve about the axis line A-A. Furthermore, due the presence of the first bearing 200, the second bearing 400, and the plurality of rollers 350, resistance to rotation about the axis line A-A may be minimized or reduced.

FIG. 4 is a sectioned-perspective view of the first interfacing member 100 in accordance with example embodiments. As shown in FIG. 4, the first interfacing member 100 may include a flange 105 and a shaft 150 extending from the flange 105. In example embodiments, the flange 105 may resemble disc having a varying thickness and the shaft 150 may resemble a hollow cylinder. In the figures, a section view of the flange 105 and the shaft 150 is provided for simplicity, but it is understood that the flange 105 and the shaft 150 may be a substantially symmetric structure such that the portions not illustrated in the figures may resemble the shown portions. Accordingly, the flange 105 may resemble a full disk rather than half a disk and the shaft 150 may resemble a full cylinder rather than half a cylinder. Example embodiments, however, do not require absolute symmetry, however. Accordingly, the missing portions may deviate from the illustrated portions.

In example embodiments, the flange 105 may include an mounting portion 110 configured to interface with an external structure. For example, the mounting portion 110 may be configured to interface with a root of a wind turbine blade. In the nonlimiting example shown in the figures, the mounting portion 110 is a substantially annular area through which a plurality of holes 120 may be formed. In example embodiments, a spacing of the plurality of holes 120 may match a spacing of a plurality of holes or a spacing of connecting members that may be present in the external structure. For example, if the external structure is a wind turbine blade, the wind turbine blade may include a root having a plurality of studs or bolts protruding therefrom. In example embodiments, the plurality of studs or bolts may be inserted into the plurality of holes 120 of the mounting portion 110 and secured thereto via a plurality of nuts. An mounting portion 110 with holes, however, is not intended to limit the invention. For example, rather than providing a plurality of holes 120 in the mounting portion 110, a plurality of studs may be provided which may, in turn, be inserted into a structure having a plurality of holes. Thus, in this latter embodiment, the plurality of studs may be attached to the structure by inserting the studs into the holes of the structure and securing them in place with a plurality of nuts. Of course, the mounting portion 110 is not required to have holes or studs. For example, the mounting portion 110 may be configured to act as a receiving surface for a structure which may be welded to the first interfacing member 100 at the mounting portion 110.

Although the first mounting portion 110 has been described and illustrated as an annular area, the invention is not limited thereto. For example, the mounting portion 110 may have an irregular shape or may have a regular shape such as, but not limited to, a triangular, square, rectangular, hexagonal, or octagonal shape. Furthermore, although the mounting portion 110 is illustrated as being flat, example embodiments are not limited thereto as the mounting portion 110 may include undulations, may be stepped, or may be sloped.

In example embodiments the shaft 150 of the first interfacing member 100 may resemble a hollow cylindrical structure. For example, in example embodiments, the shaft 150 may resemble a hollow cylinder having a first outside diameter D1 and an inside diameter D2. In example embodiments, the first outside diameter D1 may be substantially constant throughout a length of the shaft 150, however, example embodiments are not limited thereto. For example, an end of the shaft 150 may have a second outside diameter D3 which may be about the same size, or smaller than the first outside diameter D1. As yet another example, the shaft 150 may include multiple diameters, both inside and/or outside, forming a stepped shaft. In addition, an outside of the shaft 150 may be tapered or sloped.

In example embodiments, the shaft 150 may have a threaded area 160. The threaded area 160, for example, may be configured to interact with threads 720 of a nut 700 (see FIG. 18) that may be used to secure various elements of the assembly 1000 in place. Although example embodiments illustrate the shaft 150 as including a threaded area 160, example embodiments are not limited thereto as other structures may be used to secure the various elements of the assembly 1000 together. For example, rather than using a threaded nut 700, a collar and a through pin configured to extend through a cross section of the shaft 150 may be provided to secure the various members of the assembly 1000 in place. As yet another example, a collar may be provided in a location where the nut is provided and welded in place to secure the various members of the assembly 1000 in place.

In example embodiments, the flange 105 of the first interfacing member 100 may include a first surface 130 and a second surface 140 configured to face a third surface 260 and a fourth surface (for example, an outside surface of the bearing plate 230) of the first bearing 200. In accordance with example embodiments, the first surface 130 may resemble a ring that forms a full circle. However, example embodiments are not limited thereto. For example, the first surface 130 may only provide a few points of contact for the third surface 260 of the first bearing 200. In example embodiments, the second surface 140 may resemble substantially flat annular surface upon which the fourth surface may contact, but example embodiments are not limited thereto. For example, the second surface 140 may be configured so that only a few points contact the fourth surface.

FIG. 5A illustrates a perspective view of the first bearing 200 in accordance with example embodiments. As shown in FIG. 5A, the example first bearing 200 may include a retainer 210, a spacer 220, a plurality of rollers 250 (see FIG. 5B), a first bearing plate 230, and a second bearing plate 240. In FIGS. 5A-5B, only half the of first bearing 200 is shown, but it is understood that the first bearing 200 may resemble a ring like structure due to symmetry. In example embodiments, the retainer 210 may be configured with the third surface 260 that may be configured to face the first surface 130 of the first interfacing member 100. In example embodiments, the first and third surfaces 130 and 260 may be substantially parallel with one another as shown in the figures.

FIG. 5B illustrates an exploded view of the first bearing 200 in accordance with example embodiments. As shown in at least FIG. 5B, the spacer 220 may have a ring shaped body 222 (only half of which is shown in FIG. 5B) from which a plurality of extending members 225 (only half of which is shown in FIG. 5B) may extend. The plurality of extending members 225 may have concave surfaces to accommodate the plurality of rollers 250 (only half of which is shown). For example, referring to FIG. 5C, the plurality of rollers 250 may be inserted between the plurality of extending members 225 to form first intermediate bearing structure 220*. In example embodiments, the plurality of extending members 225 may not completely enclose the plurality of rollers 250. For example, sides of the plurality of rollers 250 may be exposed. In example embodiments, the intermediate bearing structure 220* and the retainer 210 may be combined to form a second intermediate bearing structure 210* as shown in FIG. 5D. In the second intermediate bearing structure 210*, the plurality of bearings 250 are held captive by the retainer 210 and the spacer 220. However, in example embodiments, sides of the plurality of rollers 250 may be exposed.

Referring to FIG. 5E, the second intermediate structure 210* may be sandwiched between the first bearing plate 230 and the second bearing plate 240 to form the bearing 200. In example embodiments, each of the first and second bearing plates 230 and 240 may resemble annular plates, only half of which is illustrated in the figures. In its completed form, the first bearing 200 may resemble a substantially ring like structure with each of the first bearing plate 230 and the second bearing plate 240 bearing against the rollers 250 captured by the retainer 210 and the spacer 220. In example embodiments, outer diameters of the first and second bearing plates 230 and 240 may be smaller than inner diameters of the retainer 210 and thus may be free to rotate along the rollers 250.

FIGS. 6A and 6B illustrate an example of the first bearing 200 arranged at a second side of the flange 105. As shown in FIG. 6A, the third surface 260 of the first bearing 200 may face the first surface 130 of the first interfacing member 100 and the first bearing plate 230 may face the second surface 140 of the first interfacing member 100. In example embodiments, the third surface 260 and the first surface 130 may contact each other in at least one location. Similarly, the first bearing plate 230 and the second surface 140 may contact each other in at least one location. Because the first bearing plate 230 is free to rotate against the plurality of roller 250, the bearing plate 230 provides little to no rotational resistance against the first interfacing member 100. In other words, the first interfacing member 100 may rotate about its shaft 150 even if it is pressed against the bearing plate 230.

FIGS. 7A and 7B illustrate an example of a second interfacing member 300 in accordance with example embodiments. For sake of simplicity, only half of the second interfacing member 300 is illustrated. It is understood, however, that the second interfacing member 300 may be a substantially symmetrical structure and thus may resemble a ring like structure.

In example embodiments, the second interfacing member 300 may include a second mounting portion 310 extending from a body 315. In example embodiments, the second mounting portion 310 may resemble an annular ring with a second plurality of holes 320 formed therein. In example embodiments, the second plurality of holes 320 may be configured to receive a plurality of attachment members, for example, bolts or studs, for attaching the second interfacing member 300 to a structure, for example, a hub of a wind turbine. Example embodiments, however, are not limited by the instant feature. For example, rather than having a plurality of holes 320 provided in the second mounting portion 310, studs may be provided instead. These studs may used to attach the second interfacing member 300 to the structure by inserting the studs into a plurality of holes formed in the structure. Further yet, the second mounting portion 310 may be formed without holes or studs and may simply act as a receiving surface for welding the second interfacing member 300 to the structure.

In example embodiments, the second interfacing member 300 may further include a seventh surface 332 and an eighth surface 333. The seventh surface 332 may be configured to face a fifth surface 270 that may be part of the first bearing 200 and the eighth surface 333 may be configured to face a sixth surface of the second bearing 200 which may be an outside surface of the second bearing plate 240. In addition, the second interfacing member 300 may include a substantially cylindrical surface 330 which may be configured to receive the rollers 350. For example, the substantially cylindrical surface 330 may have a diameter D4 ad shown in FIG. 7A.

As mentioned above, the second interfacing member 300 may include a surface 330 which may be configured to receive rollers 350. A nonlimiting example of the rollers is illustrated in FIG. 8. As shown in FIG. 8, the rollers 350 may be comprised of an outer race 360, an inner race 370, and a plurality of rollers 380 between the outer race 360 and the inner race 370. In FIG. 8, only half of the rollers 350 is shown. However, it is understood that the rollers 350 may be substantially a symmetrical structure. Thus, although the outer race 360 and the inner race 370 are illustrated as a half a cylinder, it is understood that the outer and inner races 360 and 370 more closely resemble short cylinders.

In example embodiments, the inner race 370 may be configured to fit over the shaft 150 of the first interfacing member 100. Thus, in example embodiments, an inner diameter of the first race D6 may be about the same as an outer diameter D1 of the shaft 150. Similarly, because the rollers 350 are configured to fit into the second interfacing member 300, an outer diameter D5 of the outer race 360 may be about the same as the diameter D4 of the substantially cylindrical surface 330 of the second interfacing member 300.

In example embodiments, each of the outer and inner races 360 and 370 may include protrusions to retain the rollers 380. For example, as shown in FIG. 8, the outer race 360 may include a first protrusion 362 and a second protrusion 363 extending along an outer periphery of the outer race 360. Similarly, the inner race 370 may include a protrusion 372 along its outer periphery to help keep the rollers 380 retained therein.

FIG. 9 illustrates the second interfacing member 300 receiving the pluralities of rollers 350. As shown in FIG. 9, the plurality of rollers 350 fits into the substantially cylindrical surface 330 of the second interfacing member 300.

FIG. 10 illustrates the second interfacing member 300 (with the rollers 350) on the shaft 150 of the first interfacing member 100. In example embodiments, the second interfacing member 300 may be arranged so that the first bearing 200 is between the flange 105 of the first interfacing member 100 and the second interfacing member 300. In example embodiments, the presence of the rollers 350 between the second interfacing member 300 and the shaft 150 prevents the second interfacing member 300 from applying a force that might inhibit a rotation of the first interfacing member 100. Similarly, the presence of the first bearing 200 between the second interfacing member 300 and the first interfacing member 100 prevents the second interfacing member 300 from applying a force that might inhibit a rotation of the first interfacing member 100. Thus, in example embodiments, the first interfacing member 100 is not capable of applying a force to prevent the first interfacing member 100 from rotating about its axis A-A due to the presence of the intervening first bearing 200 and the rollers 350.

FIG. 11 is a view of the second bearing 400 in accordance with example embodiments. Like the first bearing 200, the second bearing 400 may include a retainer 410, a spacer 420, a pair of bearing plates 430 and 440, and a plurality of rollers. The bearing 400 may further include a surface 470 which may face an eighth surface 334 that may be on the second interfacing member 300. Because the second bearing 400 is substantially similar to the first bearing 200, a description thereof is omitted for the sake of brevity.

FIG. 12 illustrates the second bearing 400 on the shaft 150 of the first interfacing member 100. As shown in FIG. 12, the second bearing 400 is arranged on a second side of the second interfacing member 300. Further, the surface 470 of the second bearing 400 is arranged to face the eighth surface 334 of the second interfacing portion 300. In example embodiments, due to bearing plate 430 being supporting by a plurality of rollers 450, the bearing plate 430 may not offer a rotation resistance to the second interfacing member 300.

FIG. 13 is a view of the cover 500 in accordance with example embodiments. Consistent with the other figures, only half of the cover 500 is shown for the sake of simplicity. In example embodiments, the cover 500 may include an outer portion 510 connected to an inner portion 520 by a web 530. The outer portion 510 may resemble a short cylinder having an outer surface that may face a surface 460 of the second bearing 400. In example embodiment, the inner portion 520 may resemble a short cylinder through which the shaft 150 of the first interfacing member 100 may be inserted. For example, the inner portion 520 may have an inner diameter D7 which is substantially the same as, or slightly larger than, the outer diameter D1 of the shaft 150. In example embodiments, an outer portion of the inner portion 520 may be notched to form a cylindrical mating area 540 that may be configured to receive a portion of a clamp 600. In example embodiments the mating area 540 may resemble a cylindrical area having a diameter D8.

As shown in FIG. 14, the cover 500 may be fit over the shaft 150 of the first interfacing member 100 and may be arranged so that the second bearing 400 is between the cover 500 and the second interfacing member 300. In example embodiments, the cover 500 may bear against the second bearing plate 440 of the bearing 400. However, because of the bearing plate 440 is supported by the rollers 450, the second interfacing member 300 cannot apply a force to inhibit a rotation of the cover 500. Thus, in example embodiments, the cover 500 may attach to the shaft 150 and thus, may rotate along with the shaft 150.

FIG. 15 illustrates an example of a clamp 600 and FIG. 17 illustrates and example of lock washer 550. In example embodiments, the clamp 600 may resemble a short cylinder having an inner diameter D9 of equal to, or slightly larger than, the diameter D8 of the cover 500. Thus, in example embodiments, the clamp 600 may actually fit over a portion of the cover 500. In example embodiments, the washer 550 may substantially resemble a cylinder with ears 570 extending from a body portion 560. An inner diameter D10 of the body portion may be about the same as, or slightly larger than, a diameter D1 of the shaft 150 of the first interfacing member. FIG. 17 is a view of the clamp 600 and the washer 550 on the shaft 150 of the first interfacing member.

FIG. 18 is a view of the nut 700 in accordance with example embodiments. Consistent with the other figures, only half of the nut 700 is illustrated. In example embodiments, the nut 700 may resemble a cylinder having threads 720 on an inner surface of a body 710. In example embodiments, the thread 720 may be configured to engage the threads of the threaded area 160 of the shaft 150.

FIG. 19 illustrates the nut installed on the shaft 150. In example embodiments, as the nut 700 is turned, it is advanced along the threads of the threaded area 160. In example embodiments, the nut 700 may be turned far enough so that it bears against the washer 550 applying a clamping force between the flange 105 and the washer 550 thus allowing each of the first interfacing member 100, the first bearing 200, the second interfacing member 300, the second bearing 400, the cover 500, the clamp 600 and the washer 550 to be compressed together. However, this aspect of example embodiments is not intended to be a limiting feature. For example, in example embodiments, the nut 700 may be advanced close enough to the washer 550 so that any motion that might tend to separate any one of the first interfacing member 100, the first bearing 200, the second interfacing member 300, the second bearing 400, the cover 500, the clamp 600 and the washer 550 would be stopped by the nut 700. Thus, the nut 700 may not compress any one of the first interfacing member 100, the first bearing 200, the second interfacing member 300, the second bearing 400, the cover 500, the clamp 600 and the washer 550 but may simply prevent them from separating from each other.

Although example embodiments illustrate the assembly 1000 as including the nut 700, the invention is not limited thereto. For example, the nut 700 may be replace by another securing structure, for example, a collar, which may be pinned or welded in place.

FIG. 20 illustrates an example of a second clamp 800 in accordance with example embodiments. In example embodiments, the second clamp 800 may resemble a short cylinder having an inner diameter D10 of equal to, or slightly larger than, the diameter D3 of the shaft 150. Thus, in example embodiments, the clamp 800 may actually fit over a portion of the shaft 150. FIG. 21 is a view of the second clamp 800 on the shaft 150 of the first interfacing member 100.

Referring back to FIG. 3, it is observed that various spacers maybe provided between the first clamp 600 and the second clamp 800. These spacers may provide for a relatively constant separation between the first and second clamps 600 and 800 providing stability to the structure.

In FIG. 3, an arm 900 is illustrated at a second end of the shaft 150. In example embodiments, the arm 900 may be attached rigidly to the shaft 150. For example, the arm 900 may be welded to the shaft 150. As another example, the arm 900 may be clamped to the shaft 150 using a key so that the shaft 150 rotates as the arm 900 is rotated. In either case, a rotation of the shaft 150 may be controlled by a rotation of the arm 900. In example embodiments, the arm 900 may be controlled by an actuator, for example, a hydraulic cylinder or pneumatic cylinder. Example embodiments, however, are not limited thereto. For example, rather than providing an arm 900, the second end of the shaft 150 may be fitted with a sprocket that engages a gear attached to a motor or may be attached to a chain that is attached to a motor. Thus, in example embodiments, the shaft 150 may be rotated by operating a motor.

In example embodiments, the assembly 1000 may further include a tube 980, a first insulating plate 985, and a second insulting plate 990. In example embodiments, the tube 980 may be made from a material such as fiberglass, though example embodiments are not limited thereto. In example embodiments, the tube 980 may have an outer diameter which may be about the same as an inner diameter D2 of the shaft 150. In example embodiments, the first insulating plate 985 may cover a substantial portion of the flange 105 and the second insulating plate 990 may cover a substantial portion of the second end of the shaft 150.

Example embodiments provide an assembly 1000 with two interfacing members 100 and 300. The first interfacing member 100 may connect to a first structure, for example, a wind turbine blade, and the second interfacing member may be connected to a structure, for example, a hub of a wind turbine. In example embodiments, the assembly may include a first bearing 200 and a set of rollers 350 between the first interfacing structure 100 and the second interfacing structure 300 to prevent the second interfacing structure 300 from applying a force that might inhibit a rotation of the first interfacing structure 100. In example embodiments, a cover 500 may be attached to the first interfacing structure 100 and a second bearing 400 may be provided between the cover 500 and the second interfacing structure 300 to prevent the second interfacing structure 300 from applying a force to the cover to prevent its ability to rotate. In example embodiments, the first interfacing structure 100 may have a shaft 150 with an end configured to rotate the shaft 150. For example, an end of the shaft 150 may be fitted with an arm 900 or a sprocket so that when the arm 900 or sprocket is rotated, the shaft 150 may rotate. In example embodiments, the arm 900 or sprocket may be controlled by an actuating device which may be a cylinder (for example, a hydraulic or pneumatic cylinder) or a motor.

Example embodiments of the invention have been described in an illustrative manner. It is to be understood that the terminology that has been used is intended to be in the nature of words of description rather than of limitation. Many modifications and variations of example embodiments are possible in light of the above teachings. Therefore, within the scope of the appended claims, the present invention may be practiced otherwise than as specifically described.

What is claimed is:

1. An assembly comprising:
a first interfacing member having a first mounting portion and a shaft;
a second interfacing member having a second mounting portion, the second interfacing member being arranged on a second side of the first interfacing member;
a first bearing between the first interfacing member and the second interfacing member; and
a set of rollers between the second interfacing member and the shaft of the first interfacing member.

2. The assembly according to claim 1, wherein the set of rollers are configured to allow the first interfacing member to rotate relative to the second interfacing member.

3. The assembly according to claim 2, wherein the first interfacing member contacts a first bearing plate of the first bearing and the second interfacing member contacts a second bearing plate of the first bearing.

4. The assembly according to claim 3, wherein the first bearing includes a plurality of rollers between the first bearing plate and the second bearing plate.

5. The assembly according to claim 1, further comprising:
a cover on a second side of the second interfacing member; and
a second bearing between the cover and the second interfacing member.

6. The assembly according to claim 5, wherein the cover contacts the shaft of the first interfacing member and is configured rotate as the shaft rotates.

7. The assembly according to claim 6, wherein the second bearing is configured to allow the cover to rotate independent of the second interfacing member.

8. The assembly according to claim 5, further comprising:
a nut configured to press the cover against the second bearing.

9. The assembly according to claim 8, further comprising:
a pivot arm arranged near an end of the shaft of the first interfacing member, the pivot arm being configured to connect to a cylinder.

10. The assembly according to claim 9, further comprising:
an insulating plate on the first interfacing member; and
a tube in the shaft of the first interfacing member.

11. The assembly according to claim 1, wherein the first interfacing member includes a first surface and an the second interfacing member includes a second surface, and the first surface and the second surface contact a retainer of the first bearing.

12. The assembly according to claim 1, wherein the set of rollers are enclosed by a first race and a second race.

13. The assembly according to claim 12, wherein the second interfacing member includes a body having a cylindrical surface having a diameter substantially the same as an outer diameter of the second race.

14. The assembly according to claim 13, wherein the first race has an inner diameter which is substantially the same as an outer diameter of the shaft of the first interfacing member.

15. A wind turbine comprising:
a turbine blade;
a hub; and
the assembly according to claim 1, wherein the turbine blade is attached to the first interfacing member and the hub is attached to the second interfacing member.

16. The wind turbine according to claim 15, wherein an end of the assembly is configured to attach to an actuating device so that when the actuating device is activated the turbine blade rotates.

17. The wind turbine according to claim 16, wherein the actuating device is one of a cylinder and a motor.

18. The wind turbine according to claim 15, wherein the set of rollers are enclosed by a first race and a second race.

19. The wind turbine according to claim 18, wherein the second interfacing member includes a body having a cylindrical surface having a diameter substantially the same as an outer diameter of the second race.

20. The wind turbine according to claim 19, wherein the first race has an inner diameter which is substantially the same as an outer diameter of the shaft of the first interfacing member.
